(19) United States
(12) Patent Application Publication
(10) Pub. No.: US 2006/0012592 A1
(43) Pub. Date: Jan. 19, 2006

(54) Electronic equipment equipped with display panel

(75) Inventors: Hiroyuki Sato, Yonezawa-shi (JP); Naoto Suzuki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/180,781

(22) Filed: Jul. 14, 2005

(30) Foreign Application Priority Data
Jul. 15, 2004 (JP) 2004-208944

(51) Int. Cl. G09G 5/00

(52) U.S. Cl. 345/204

(57) ABSTRACT

A driver section 2 and a display control section B are loaded in a display module A, and an EL display 1 is driven to emit light by an image signal provided from the display control section B. An image generation section 5 in the display control section B generates the image signal for scrolling and displaying a still image showing a time in a wait state in which operations such as key input and the like are not performed for a predetermined time period. In this case, during a period from an end of scroll display of one still image to the start of the scroll display of the next still image, a non-display period in which the still image is not displayed on the display panel is set. During this non-display period, supply of a clock signal from a clock signal generation section 3 which particularly drives the driver section 2 is stopped, and power consumed during this period is reduced.

### BACKGROUND OF THE INVENTION

1. Field of the Invention

The present invention relates to electronic equipment which is suitably adopted for example in a portable type data terminal and the like and which is equipped with a display panel having a function that reduces the power consumption during a wait time period or the like.

2. Description of the Related Art

The popularity of portable type data terminals such as for example portable telephones, personal digital assistants (PDAs), or the like which utilize a battery as a power source has been increasing rapidly. Regarding this kind of data terminal, Japanese Patent Application Laid-Open No. Hei 9-26837 discloses a means for prolonging the use time of the battery by limiting the function of the display panel loaded in this terminal to decrease the power consumption in a wait state in which operations such as key input and the like are not performed for a predetermined time period.

Japanese Patent Application Laid-Open No. 2000-244351 discloses that a main clock signal is stopped during the above-mentioned wait time period and that a minimum administration and control in the system is performed while a low frequency clock signal is utilized to decrease the power consumption of the battery similarly.

Meanwhile, regarding the above-mentioned portable type data terminals, conventionally, a liquid crystal display panel has been adopted in many products as a display panel which is a thin type and which can realize low power consumption as one satisfying the needs thereof. Further, these days, a light emitting display panel employing organic EL (electroluminescent) elements which make the best use of a characteristic of being a self light emitting type element has been loaded in some products, and this panel has attracted attention as a next generation display panel which may be employed in place of a conventional liquid crystal display panel. A background thereof is that by employing, in a light emission functional layer of the EL element, an organic compound which enables an excellent light emission characteristic to be expected, a high efficiency and a long life which can be equal to practical use have been advanced.

The organic EL element is formed basically in such a way that a transparent electrode for example by ITO, an organic EL medium, and a metallic electrode are laminated one by one on a transparent substrate. The organic EL medium may be a single layer of an organic light emitting layer, or a double layer structure composed of an organic positive hole transport layer and an organic light emitting layer, or a triple layer structure composed of an organic positive hole transport layer, an organic light emitting layer, and an organic electron transport layer, or a multilayer structure in which an injection layer of electron or positive hole is inserted into an appropriate portion among these layers.

Meanwhile, it has been known that the light emission intensity characteristic in the organic light emitting layer of the above-described organic EL element decreases with the passage of actual light emitting time, and therefore in a case of a state in which the same still image is displayed for a long period of time, a so-called image sticking phenomenon occurs. In order to prevent such an image sticking phenomenon, for example, a means for scrolling and displaying still image information can be suitably adopted.

### SUMMARY OF THE INVENTION

It is an object of the present invention to provide electronic equipment equipped with a display panel which can reduce power consumption further in a case where a scroll mode is set in which still image information is controlled to be scroll-displayed on the display panel.

Electronic equipment equipped with a display panel according to the present invention which has been developed in order to solve the problem is in electronic equipment equipped with at least one display panel for displaying still image information such as letters, marks, pictures, and the like, said electric equipment comprising means for executing a scroll-display mode such that said still image information is controlled to be scroll-displayed on said at least one display panel; means for providing a non-display period after said scroll-display mode has been executed and before another scroll-display mode is executed such that there is no scroll display of any still image information on said at least one display panel; and means for executing a rewrite operation into still image information to be controlled to be scroll-displayed during said non-display period.

### BRIEF DESCRIPTION OF THE DRAWINGS

FIG. 1 is a block diagram showing an embodiment according to the present invention;

FIG. 2A, FIG. 2B and FIG. 2C are flow charts explaining operations performed in the embodiment shown in FIG. 1;

FIG. 3A, FIG. 3B and FIG. 3C are schematic views showing forms of scroll operations which can be adopted in the embodiment shown in FIG. 1; and

FIG. 4 is a schematic view showing a form of another scroll operation similarly.

### DESCRIPTION OF THE PREFERRED EMBODIMENTS

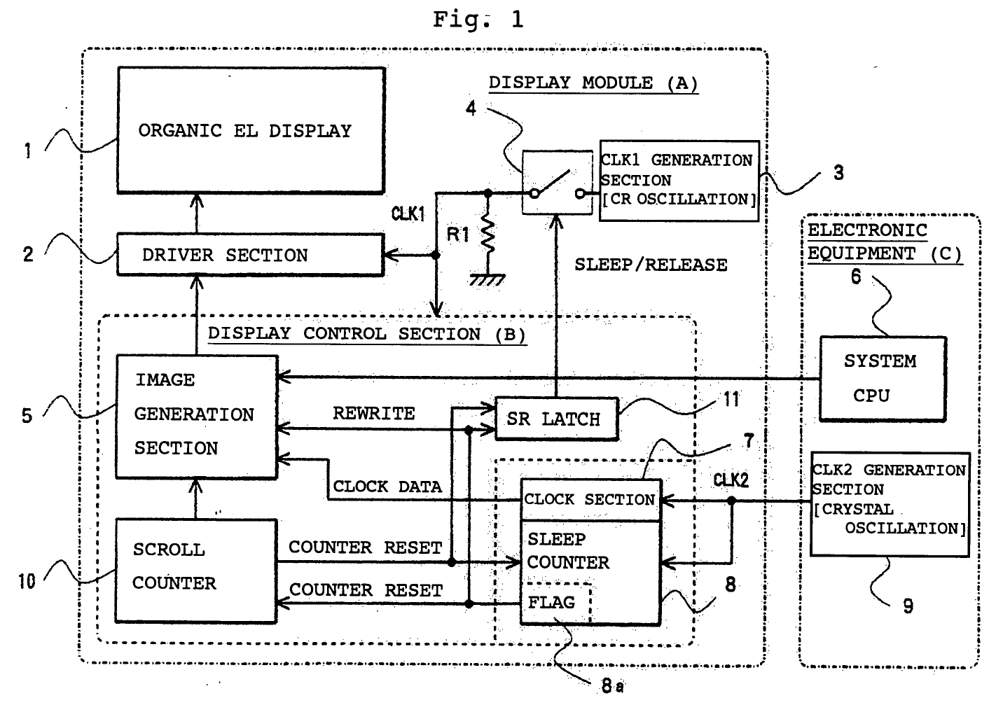

Electronic equipment equipped with a display panel according to the present invention will be described below based on an embodiment shown in FIG. 1. Reference numeral 1 shown in FIG. 1 denotes an organic EL display (display panel) in a display module A, and this is constructed such that light emission control is performed by a driver section 2. The driver section 2 in detail can be divided into a scan driver and a data driver, and these are both constructed to operate based on a first clock signal (CLK 1) provided from a first clock generation section 3 equipped in the display module A.

The first clock generation section 3 is for example constituted by a CR oscillator, and the first clock signal generated in this first clock generation section 3 has a frequency higher than that of a second clock signal (CLK2) generated in a later-described second clock generation section. This first clock signal (CLK1) is supplied to the driver section 2 via an analog switch 4 of a C-MOS structure, and for this, a pull-down resistor R1 is connected between the output side of the analog switch 4 and a reference potential point. The first clock signal from the first clock generation section 3 is also supplied to a later-described display control section B via the analog switch 4.

Meanwhile, a video signal is supplied from an image generation section 5 in the display control section B to the driver section 2, thereby the EL display 1 is controlled to be lit. Image data displayed on the EL display 1 is supplied from a system CPU 6 equipped in electronic equipment C side in which this display module A is loaded to the image generation section 5.

A command signal for shifting to a scroll mode in a wait state in which operations such as key input and the like in the electronic equipment C side are not performed for a predetermined time period and a command release signal for shifting from the scroll mode to a normal display mode at the time operations such as key input and the like are begun to be performed are supplied from the system CPU 6 to the image generation section 5.

A clock section 7 and a sleep counter 8 are provided in the display control section B, and the second clock signal (CLK2) is supplied from the second clock generation section 9 composed of a crystal oscillator provided in the electronic equipment C side to these clock section 7 and sleep counter 8. That is, the clock signal from the second clock generation section 9 is utilized in time measurement in the clock section 7 and is utilized so as to set a duration of a sleep mode in the sleep counter 8 as described later.

The clock section 7 executes the time measurement based on the clock signal (CLK2) supplied from the second clock generation section 9 and supplies clock data to the image generation section 5 in the case of the scroll mode to generate still image information showing a time in the image generation section 5 as described later. Thus, during the scroll mode, the still image information showing a time is scroll-displayed on the EL display 1.

Meanwhile, a scroll counter 10 is provided in the display control section B, and this scroll counter 10 operates to perform a count operation by the clock signal (CLK1) provided from the first clock generation section 3. In the case of the scroll mode, this scroll counter 10, based on the clock data, manages the number of characters of the still image information showing a time generated in the image generation section 5, in other words, a time required to allow the still image information to be scrolled one time.

Although scroll operations including those in the scroll counter 10 will be described in detail later, the scroll counter 10 is constructed so as to supply a counter reset signal to the sleep counter 8 when the first clock signal (CLK1) counts up to a preset value. The counter reset signal from the scroll counter 10 is supplied to an SR latch circuit 11, that is, a set/reset latch circuit, to operate to reset this SR latch circuit With this, since the SR latch circuit 11 turns the analog switch 4 off, supply of the clock signal (CLK1) from the first clock generation section 3 is stopped. This state will be called the sleep mode. Upon receiving the counter reset signal from the scroll counter 10, the sleep counter 8 begins to perform count up of the second clock signal (CLK2) supplied from the second clock generation section 9, and when the second clock signal counts up to the preset value, the sleep counter 8 performs control to raise a flag 8a, that is, generates the counter reset signal.

Thus, the scroll counter 10 is reset, and a set signal is supplied to the SR latch circuit 11. Accordingly, the analog switch 4 is turned on, and the above-mentioned sleep state is released. At this time, the counter reset signal from the sleep counter 8 is supplied to the image generation section 5 as a rewrite signal so that a rewrite operation of the still image information showing a time based on the clock data from the clock section 7 can be executed.

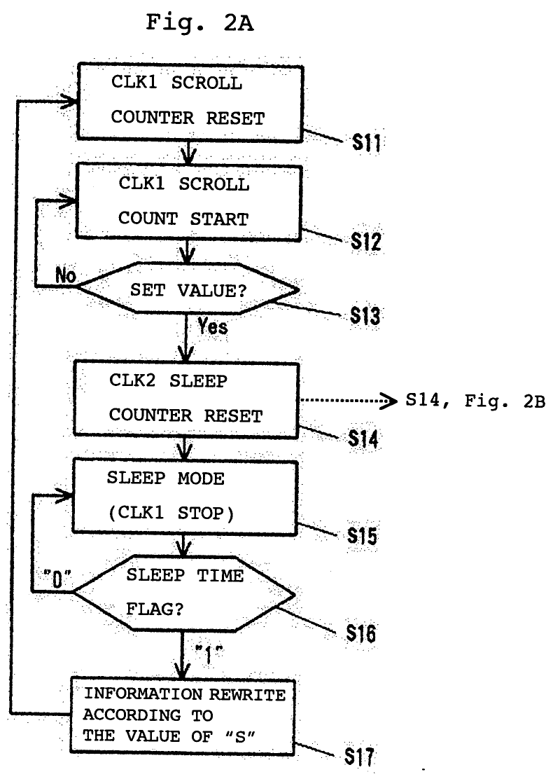

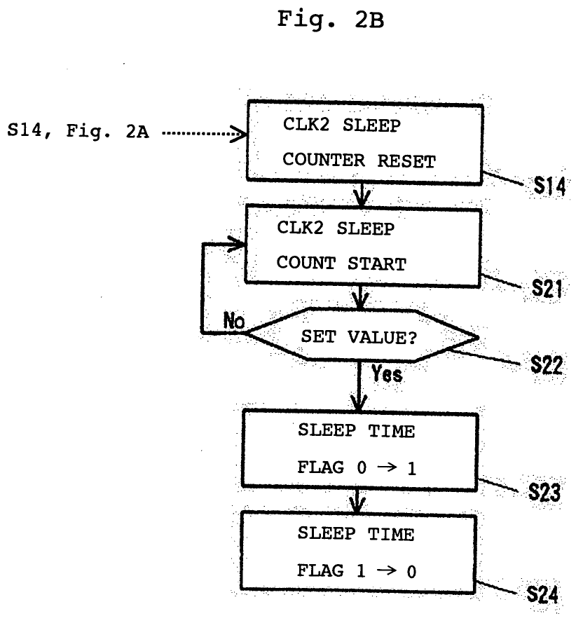

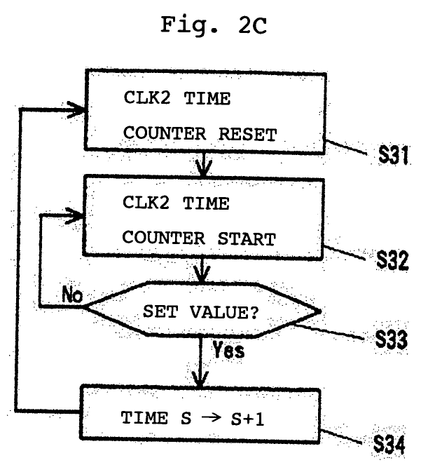

FIG. 2A through FIG. 2C explain further detailed operational flows of the structure shown in FIG. 1. In FIG. 2A will be called a scroll flow, FIG. 2B a sleep time flow, and FIG. 2C a time measurement flow.

First, the scroll flow shown in FIG. 2A is started when the scroll mode is set by the command signal supplied from the system CPU 6 in the wait state in which operations such as key input and the like in the electronic equipment C side are not performed for the predetermined time period as described above. At the beginning of execution of this scroll flow, the analog switch 4 shown in FIG. 1 is in an ON state, that is, the SR latch circuit 11 is in a set state.

By the start of the scroll flow, as shown in step S11, the count value of the first clock signal (CLK1) in the scroll counter 10 is reset. Then, as shown in step S12, the scroll counter 10 begins to count the number of clocks in the first clock signal (CLK1). As shown in step S13, whether or not a count-up value of the first clock signal in the scroll counter 10 has reached the preset value is monitored, and if it has been determined to have reached the set value (Yes) in step S13, then step S14 is performed.

During a period in which step S11 reaches step S13, the image generation section shown in FIG. 1 generates data of still image information showing a time based on the clock data provided from the clock section 7. Scroll control for the still image information is performed utilizing a count-up output provided from the scroll counter 10.

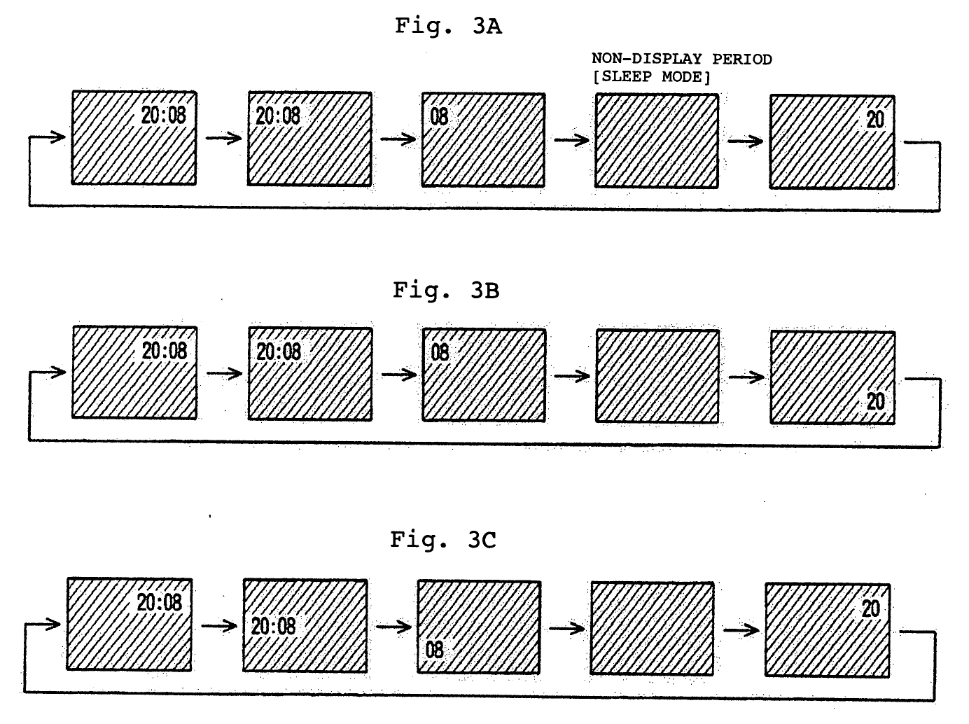

FIG. 3A shows one example and illustrates a state in which the still image information showing a time in the EL display 1 is scroll-displayed. That is, in the right end of FIG. 3A, still image information showing the time of 20:08 is displayed, and this illustrates a state of the display shortly after the scroll operation has started. The head of the still image information showing the time is sequentially scrolled from the right of the display to the left by the scroll control. When the fourth state from the leftmost state in FIG. 3A comes, the still image information is in a state in which it disappears in the screen (a non-displayed state).

This state is the state in which the set value has been determined to have been reached (Yes) in step S13 shown in FIG. 2A. In short, the “set value” in step S13 is to manage the time required from the start of the scroll operation of one still image information showing a time to the completion thereof, that is, until the still image information disappears in the screen.

In step S14 shown in FIG. 2A, the count value of the second clock in the sleep counter 8 is reset. This is performed by supply of the counter reset signal from the scroll counter 10 to the sleep counter 8 shown in FIG. 1 as described above. Thus, the SR latch circuit 11 is allowed to be reset, and the analog switch 4 is turned off to be in the sleep mode (step S 15).

In the case of the sleep mode, the supply of the first clock signal (CLK1) from the clock generation section 3 is stopped, and with this operation, operations of the driver section 2 and the scroll counter 11 operating based on the first clock signal are also stopped. In particular, since the driver section 2 operates by the first clock signal (CLK1) that has a frequency higher than that of the second clock signal (CLK2), the stopping of the operation of the driver section 2 during this sleep mode period largely contributes to reduction of the power consumption.

The sleep mode corresponds to the non-displayed period in which scroll display of the still image information is temporarily suspended, and during this period drive of the driver section 2 is also stopped. However, the EL display 1 has a normally black display characteristic, thereby not influencing displaying of the EL display 1.

Here, as shown in step S14 in FIG. 2A, if the count value of the second clock in the sleep counter 8 is reset, the sleep time flow shown in FIG. 2B is started. This sleep time flow manages the duration of the sleep mode (non-displayed period). That is, in the case of shifting to the sleep mode, as shown in step S21, the sleep counter 8 begins to count the second clock signal.

As shown in step S22, whether or not the count-up value of the second clock signal in the sleep counter 8 has reached the preset value is monitored, and in step S22 if it has been determined to have reached the set value (Yes), step S22 proceeds to step S23. At this step S23, a sleep time flag is made “1”, and at following step S24 an operation to make the sleep time flag “0” is performed. That is, here, one trigger pulse is generated, and this trigger pulse means the flag 8a outputted from the sleep counter 8.

If the process returns to the scroll flow shown as in FIG. 2A and proceeds to the sleep mode shown in step S15, as shown in step S16, whether or not “1” is raised as the sleep time flag is monitored. In the sleep time flow (b), if the process proceeds to step S23, that is, if it is verified that “1” is raised as the sleep time flag, the process proceeds to step S17.

At this step S17, the flag from the sleep counter 8 is “1” as already described, and this is supplied to the image generation section 5 as a rewrite signal. Rewriting of the still image information showing a time based on the clock data supplied at this time from the clock section 7 is executed. That is, the rewriting of time display in the still image information is implemented at the end of the sleep mode.

Here, in FIG. 2C shows the time measurement flow as described above, and this functions to find a present time. That is, this time measurement flow independently operates in the clock section 7 which employs the second clock signal (CLK2). First, as shown in step S31, the count number of the second clock signal accumulated in an unillustrated time counter incorporated in the clock section 7 is reset.

After this, as shown in step S32, the second clock signal is begun to be counted up by the time counter. As shown in step S33, whether or not the count-up value of the second clock signal in the time counter has reached the preset value is monitored, and if it has been determined to have reached the set value (Yes) in step S33, the process proceeds to step S34. In this step S34, the value of “S” showing a time is incremented, and an operation to return to step S31 again is repeated.

When it is supposed that the “S” showing a time shows in units of second, the “set value” in step S33 is set at the same value as the frequency of the second clock signal (CLK2) provided by the crystal oscillator utilized for clocking of a clock.

Therefore, in the step S17, rewriting of time display in the still image information is implemented in accordance with the value of a present time “S” found in step S34 in the time measurement flow FIG. 2C. At the same time, the SR latch circuit 11 shown in FIG. 1 is brought to the set state, and the sleep mode (non-display period) is released to allow supply of the first clock signal (CLK1) to be begun. The routine returns from step S17 back to step S11 shown in FIG. 2A, so that an operation to reset the count value in the scroll counter 10 is implemented.

Thus, as long as the release signal to shift from the scroll mode to the normal display mode does not arrive at the image generation section 5 from the system CPU 6 shown in FIG. 1, a similar scroll mode is repeatedly executed. The state illustrated in the right end of FIG. 3A shows a state of shifting from the sleep mode to the scroll mode again, that is, a state of shifting to step S11 shown in FIG. 2A.

As is apparent from the description above, with the above-described embodiment, the still image information showing a time displayed in the scroll mode is rewritten during the sleep mode, that is, during the non-display period. Accordingly, any change of time display in the middle of the scroll operation is prohibited. By setting of the sleep mode, since mainly the driver section 2 which operates by the first clock signal can be suspended, this can contribute to a large reduction in the power consumed here.

FIGS. 3B and 3C show other display patterns of the still image information in the scroll mode, and the pattern shown in 3B shows an example in which a display position of the still image information is changed for each unit scroll in the vertical direction of the display (display panel). The display pattern shown in FIG. 3C shows an example in which a display position of the still image information is moved successively for each unit scroll in a direction from the top of the display to the bottom thereof.

Any display patterns shown in FIG. 3B and FIG. 3C can effectively prevent the so-called image sticking phenomenon on the display from occurring.

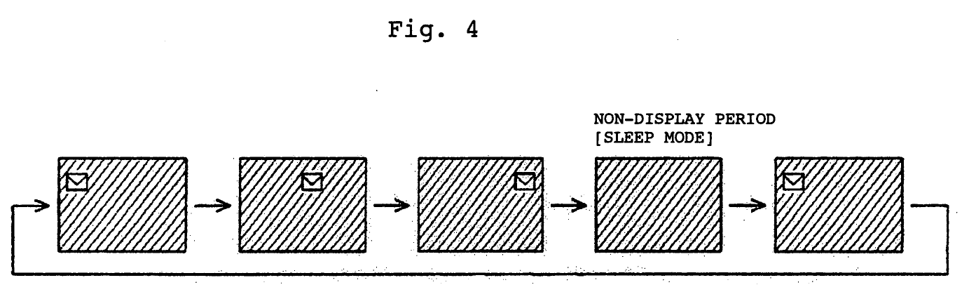

Although a time is displayed in the scroll mode in the above-described embodiment, it may be considered that the display panel is constructed in such a way that other information is scroll-displayed for example as shown in FIG. 4. In the example shown in FIG. 4, indicated is a mark showing that there is an incoming e-mail, and this image data is supplied from the system CPU 6 in the electronic equipment (C) shown in FIG. 1 to the image generation section 5 to be displayed. The incoming e-mail mark is scroll-displayed, and when the non-display period comes, the rewrite operation of the still image information is executed. Yet, in this example shown in FIG. 4, the display form of the incoming e-mail mark does not change even when the rewrite operation is performed, and rewriting to the same information is performed.

Although the embodiment described above shows an example in which organic EL elements are employed as light emitting elements in a display (display panel), a display such as a liquid crystal display device (LCD), a field emission display (FED), or the like may also be employed instead.

What is claimed is:

1. In electronic equipment equipped with at least one display panel for displaying still image information such as letters, marks, pictures, and the like, said electric equipment comprising means for executing a scroll-display mode such that said still image information is controlled to be scroll-displayed on said at least one display panel; means for providing a non-display period after said scroll-display mode has been executed and before another scroll-display mode is executed such that there is no scroll display of any still image information on said at least one display panel; and means for executing a rewrite operation into still image information to be controlled to be scroll-displayed during said non-display period.

2. The electronic equipment equipped with the display panel according to claim 1, wherein a display control section for performing display control of the display panel is constructed so as to be able to perform control based on a first clock signal and a second clock signal whose clock frequencies are different from each other and that a sleep mode in which the input of a higher frequency clock signal among the first and second clock signals is stopped during the non-display period is set.

3. The electronic equipment equipped with the display panel according to claim 2, wherein a lower frequency clock signal among the first and second clock signals isa clock signal utilized for time measurement loaded in a side of the electric equipment into which the display panel is loaded.

4. The electronic equipment equipped with the display panel according to claim 2, wherein the higher frequency clock signal is the first clock signal and that a duration of the sleep mode in which the input of the first clock signal to the display control section is stopped is set based on the second clock signal.

5. The electronic equipment equipped with the display panel according to claim 3, wherein the higher frequency clock signal is the first clock signal and that a duration of the sleep mode in which the input of the first clock signal to the display control section is stopped is set based on the second clock signal.

6. The electronic equipment equipped with the display panel according to any one of claims 1 to 5, wherein the still image information controlled to be scroll-displayed on the display panel is time information.

7. The electronic equipment equipped with the display panel according to claim 6, wherein the time information is generated based on the second clock signal utilized for time measurement.

8. The electronic equipment equipped with the display panel according to claim 1, wherein the display panel is an organic EL display panel including at least one or more organic light emission functional layer.
